(19) United States
(12) Patent Application Publication
(10) Pub. No.: US 2005/0091577 A1
(43) Pub. Date: Apr. 28, 2005

(54) Information integration system

(75) Inventors: Robert J. Torres, Colleyville, TX (US); Thomas M. Lanzetta, Lebanon, NH (US); Fitzgerald Steele JR., Waterloo, IA (US)

Correspondence Address: Robert V. Wilder, Attorney at Law, 4235 Kingsburg Drive, Round Rock, TX, 78681, US

(73) Assignee: International Business Machines Corporation, Armonk, NY (US)

(21) Appl. No.: 10/692,140

(22) Filed: Oct. 23, 2003

(51) Int. Cl. G06F 17/00

(52) U.S. Cl. 715/507

(57) ABSTRACT

A method and implementing computer system are provided for enabling a display of selective context-sensitive input-related field information concerning selected fields within a displayed information input form. In one exemplary embodiment, a field in which a cursor is placed, is enlarged relative to the remainder of the form to facilitate input to the selected field while maintaining an overall view of the remainder of the displayed form. Information is then input into the enlarged window and upon movement of the cursor to a different field, the enlarged view of the previous field is returned to normal size within the displayed form with the information input to the enlarged window being retained in the appropriate field within the form. In another embodiment, context or field-sensitive input format information and other required aspects of input information are selectively displayed in windows which are selectively positioned relative to the current input field. In an exemplary embodiment, a user is enabled to use a selection screen function to pre-determine preferred options with regard to the placement of the field-sensitive format information relative to the current input field.

### FIELD OF THE INVENTION

The present invention relates generally to information processing systems and more particularly to a methodology and implementation for facilitating electronic information input to computer systems.

### BACKGROUND OF THE INVENTION

Currently, almost all transactions of all types require an individual to input information of some sort into a computing system where it must be processed and stored. In many such transactions, the input device comprises a personal computer (PC) or laptop computer or other computing device including handheld wireless devices. To obtain the necessary information, a form is typically displayed on a display device associated with the computer and the necessary information is typed into specific fields on the displayed form. Upon completion of the form, the information is typically assembled from the fields and saved as a record for example in a database.

In order to enable as much information input as possible on a single displayed form, the information input forms are necessarily brief and most often lack adequate instructions for filing complicated forms. Moreover, the typeset used on many displayed forms is quite small and difficult to read.

While completing displayed forms, an individual typically requires many forms of assistance while still maintaining visual awareness on the overall form and the user's current position within the total form. For example, users may require assistance in determining formatting guidance for information to be entered, help tips, and tips required to insure format and data range validity. Many systems today display tool tips, help and other forms of guidance in windows which are secondary to a user's point of focus and interaction. Further, the various sources and types of information are not integrated and many times inconsistent. This results in spending an unnecessary amount of wasted time in extra work steps, re-doing inputs, excessive window management and manipulation, and needless errors due to short term memory limitations.

Thus, there is a need for an improved methodology and system for processing information input to forms which are displayed on computer-related display devices.

### SUMMARY OF THE INVENTION

A method and implementing computer system are provided for enabling a display of selective context-sensitive input-related field information concerning selected fields within a displayed information input form. In one exemplary embodiment, a field in which a cursor is placed, is enlarged relative to the remainder of the form to facilitate input to the selected field while maintaining an overall view of the remainder of the displayed form. Information is then input into the enlarged window and upon movement of the cursor to a different field, the enlarged view of the previous field is returned to normal size within the displayed form with the information input to the enlarged window being retained in the appropriate field within the form. In another embodiment, context or field-sensitive input format information and other required aspects of input information are selectively displayed in windows which are selectively positioned relative to the current input field. In an exemplary embodiment, a user is enabled to use a selection screen function to pre-determine preferred options with regard to the placement of the field-sensitive format information relative to the current input field.

### BRIEF DESCRIPTION OF THE DRAWINGS

A better understanding of the present invention can be obtained when the following detailed description of a preferred embodiment is considered in conjunction with the following drawings, in which:

FIG. 1 is a computer system which may be used in an exemplary implementation of the present invention;

FIG. 2 is a schematic block diagram illustrating several of the major components of an exemplary computer system;

FIG. 3 shows an example of a first display mode for inputting information to a first field of a displayed form for input to a computerized data base;

FIG. 4 illustrates the displayed form of FIG. 3 with an input cursor in another entry field;

FIG. 5 shows an example of a second display mode for inputting information to a first field of a displayed form for input to a computerized data base;

FIG. 6 illustrates the displayed form of FIG. 5 with an input cursor in another entry field;

FIG. 7 shows an example of a third display mode for inputting information to a first field of a displayed form for input to a computerized data base;

FIG. 8 illustrates the displayed form of FIG. 7 with the input cursor in another entry field;

FIG. 9 shows an exemplary input screen by which a user is enabled to make predetermined selections of user preferences relative to a selected form display mode; and

FIG. 10 is a flow chart illustrating an sequential operational flow in an exemplary operation of the disclosed data input system.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

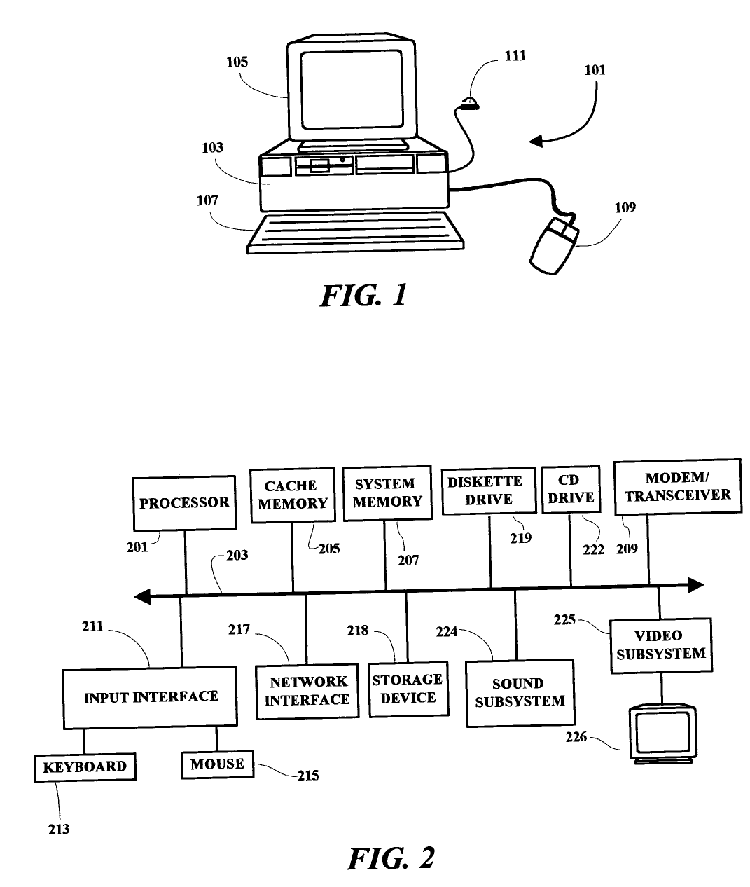

With reference to FIG. 1, the various methods discussed herein may be implemented within a computer network including a computer terminal 101, which may comprise either a workstation, personal computer (PC), laptop computer or a wireless computer system or other device capable of processing personal communications including but not limited to cellular or wireless telephone devices. In general, an implementing computer system may include any computer system and may be implemented with one or several processors in a wireless system or a hard-wired multi-bus system in a network of similar systems.

In the FIG. 1 example, the computer system includes a processor unit 103 which is typically arranged for housing a processor circuit along with other component devices and subsystems of a computer terminal 101. The computer terminal 101 also includes a monitor unit 105, a keyboard 107 and a mouse or pointing device 109, which are all interconnected with the computer terminal illustrated. Other input devices such as a stylus, used with a menu-driven touch-sensitive display may also be used instead of or in addition to the mouse device 109. Also shown is a connector 111 which is arranged for connecting a modem within the computer terminal to a communication line such as a telephone line in the present example. The computer terminal may also be hard-wired through other network servers and/or implemented in a cellular or other wireless system. The basic components shown in FIG. 1 may also be implemented in a laptop computer or other hand-held device.

Several of the major components of the terminal 101 are illustrated in FIG. 2. A processor circuit 201 is connected to a system bus 203 which may be any host system bus. It is noted that the processing methodology disclosed herein will apply to many different bus and/or network configurations. A cache memory device 205 and a system memory unit 207 are also connected to the bus 203. A modem and/or transceiver 209 is arranged for connection to external devices and/or remote networks. The modem 209, in the present example, selectively enables the computer terminal 101 to establish a communication link and initiate communication with networked servers through a network connection such as the Internet.

The system bus 203 is also connected through an input interface circuit 211 to a keyboard 213 and a mouse or other pointing device 215. The bus 203 may also be coupled through a hard-wired network interface subsystem 217 which may, in turn, be coupled through a wireless or hard-wired connection to a network of servers and mail servers on the world wide web. A diskette drive unit 219 and a CD drive unit 222 are also shown as being coupled to the bus 203. A video subsystem 225, which may include a graphics subsystem, is connected to a display device 226. A storage device 218, which may comprise a hard drive unit and/or a flash memory device, is also coupled to the bus 203. The diskette drive unit 219 as well as the CD drive 222 provide a means by which individual diskette or CD programs may be loaded into memory or on to the hard drive, for selective execution by the computer terminal 101. As is well known, program diskettes and CDs containing application programs represented by magnetic indicia on the diskette or optical indicia on a CD, may be read from the diskette or CD drive into memory, and the computer system is selectively operable to read such magnetic or optical indicia and create program signals. Such program signals are selectively effective to cause the computer system to present displays on the screen of a display device and generally respond to user inputs in accordance with the functional flow of an application program.

It is understood that the present invention applies equally well to any electronic data input system including, but not limited to, wireless and/or cellular messaging or input systems. In accordance with the present invention, a user is enabled to input text and other data into input forms displayed at a user's computer terminal. The user is aided in the input process by the selective presentation of context or field-sensitive format information, and other required aspects of input information are selectively displayed in windows which are selectively positioned relative to the current input field. In an exemplary embodiment, a user is enabled to use a selection screen function to pre-determine preferred options with regard to the placement of the field-sensitive format information relative to the current input field. The present invention applies to all applications which require the input of information by a user. Such applications may be PC-based, PDA-based or Internet-based, i.e. implementing code may be included in PC-based computer terminal applications or resident at servers remote from a user terminal, or both.

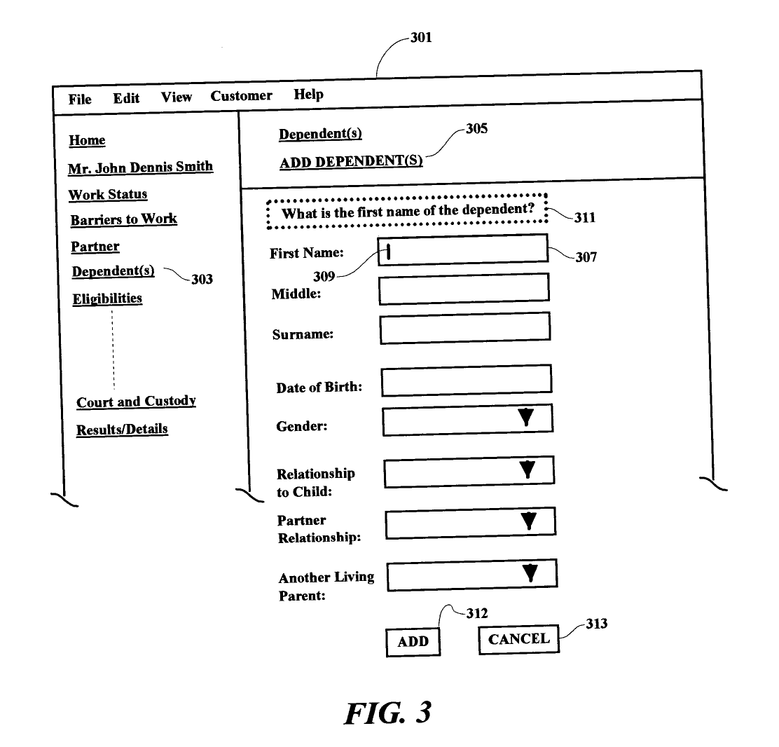

In the process of obtaining information from a user, generally a form is displayed to the user and required information is to be input by a user by filling out or inputting information to selected areas or fields within the form. The information from the completed form is then processed and stored as a record. In an illustrated example, FIG. 3 shows a form which is designed to obtain personal information from a user. The input form 301 is presented on a display of a user computer device and the user is requested to input information to the form. This is accomplished by typing information into the various fields within the form 301. Various sections 303 of the overall record are shown at the left side of the form, and, in the present example, a user has selected to provide input to an “ADD DEPENDENT(S)” section 305 of a “Dependent(s)” portion 303 of the record. The exemplary form includes a series of fields such as “First Name”, “Middle”, “surname”, and so on. In the example, a user has positioned a cursor 309 in a first field 307 of the displayed form. When the cursor is placed in the first field 307, a guidance text window 311 is selectively displayed and associated with the selected field to aid the user in filling-in the required information for the current field. Upon completing the form, in the present example, a user is enabled to either “ADD” 312 the input information into the record or “CANCEL” 313 the input operation.

As shown in FIG. 3, the guidance text window 311 is designed to provide additional “extended information” or “extended text” to a user without unnecessarily complicating the basic form. In the FIG. 3 example, the guidance or extended text is displayed in a guidance window 311 which is located directly above the field in which the cursor has been placed. In the present disclosure, the terms “extended information”, “extended text” and “guidance text” are used interchangeably to refer to predetermined text strings which are associated with each of the fields in a displayed form. The substance of the extended text may be different for every field in a displayed form and is associated with particular fields in an accessible extended text data base stored in memory. As the cursor is moved to different fields in the form, a guidance text window will be displayed above the selected field and will contain extended text information helpful and/or necessary to the user in filling-in the information required to be input to the current or selected field. The guidance or extended text may simply elaborate upon the field title as shown in FIG. 3, or the text may specify related information such as business rules, usage instructions, format guide, data validation, work aids, etc. For example, the text may specify date-related input to be in a predetermined format such as “MM/DD/YYYY” to indicate that the input date to the selected field must be input as a two digit date, a two digit month and a four digit year separated by slashes such as “04/08/1942”.

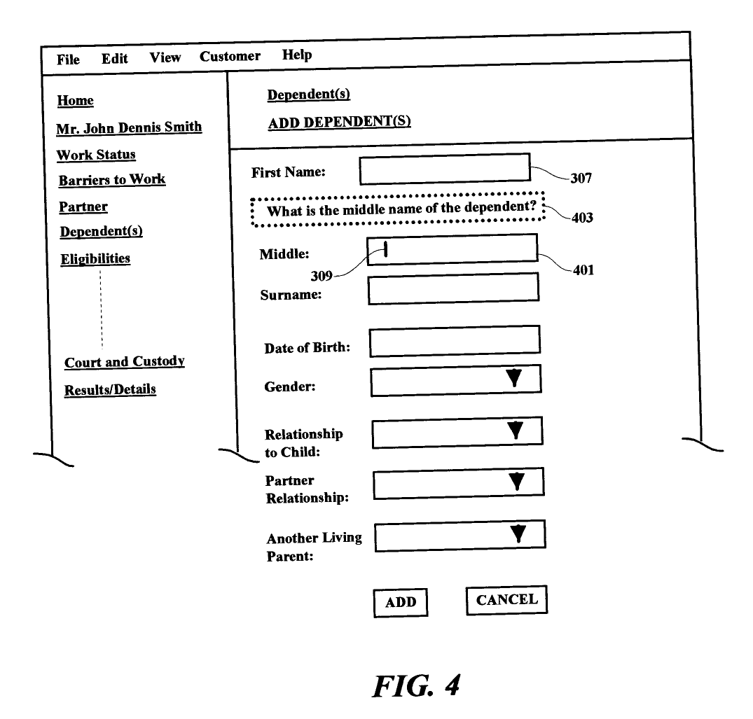

FIG. 4 illustrates the displayed form of FIG. 3 with the input cursor 309 removed from the first field 307 and placed within in a second field 401. As shown, when the cursor is within the second field 401, the guidance text window 403 appears above the selected field 401 and contains information related to the selected or current field 401.

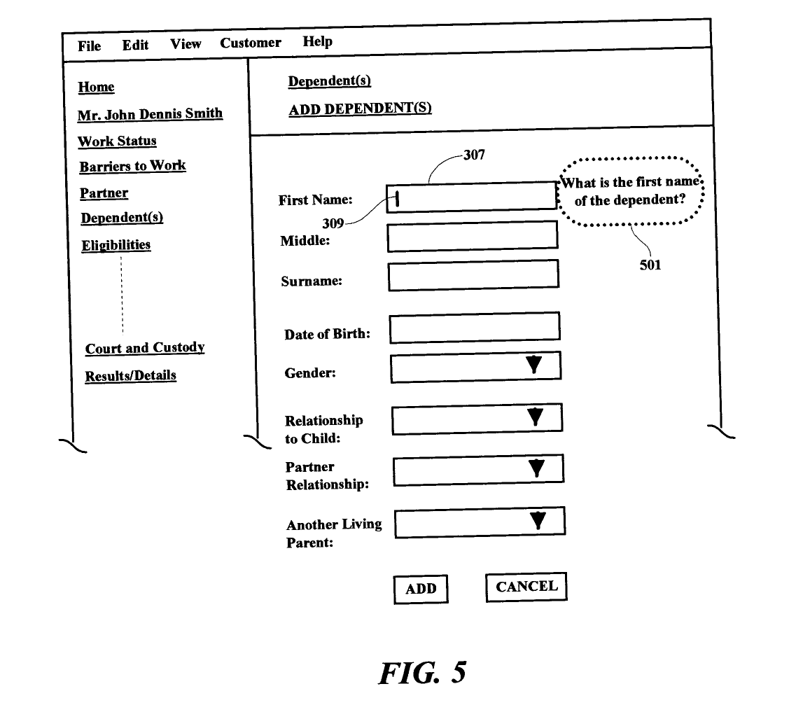

FIG. 5 illustrates another example in which the guidance text window 501 is displayed to the right side of the first field 307 when the cursor 309 is placed within the selected first field.

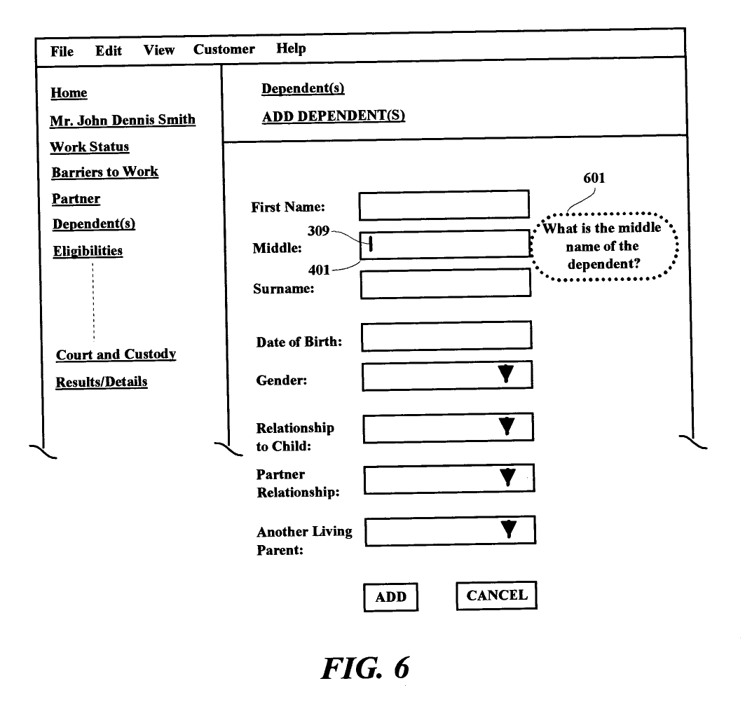

FIG. 6 illustrates another example in which the guidance text window 601 is displayed to the right side of the second field 401 when the cursor 309 is placed within the second field 401.

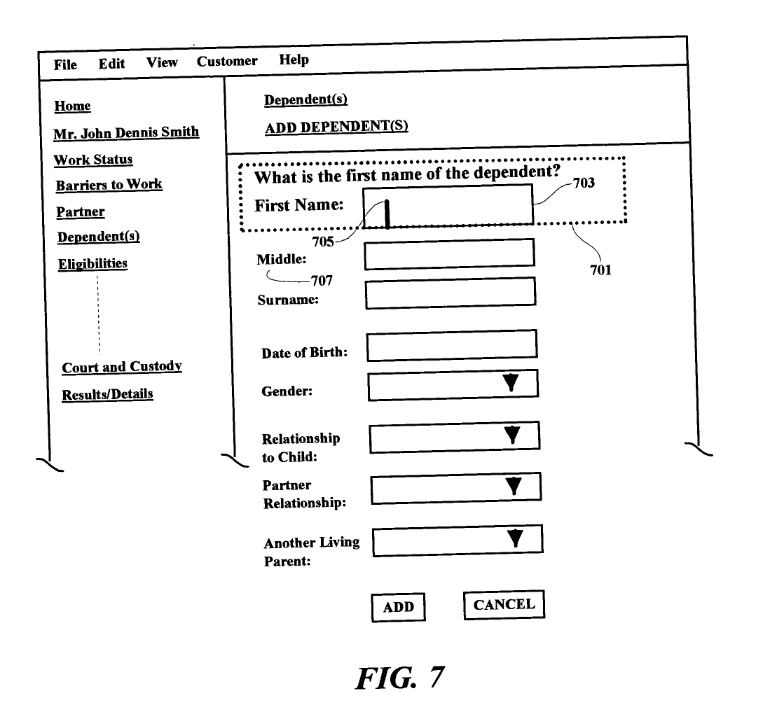

FIG. 7 illustrates another example in the use of guidance text windows to aid a user in filling-out a displayed form. As shown in FIG. 7, when the cursor 705 is placed within a first window 703, the guidance text window 701 is displayed. As illustrated, the guidance text window 701 and its contents are magnified relative to the remainder of the form to make it easier for the user to read the field name as well as the guidance text. The enlarged format of the guidance text also facilitates the input of information by the user because the input field is larger and easier to view and to visually confirm that the keyed-in information is correct and in the proper format. When the cursor is moved to another field, the display of the first field is returned to the normal display size, the information input to the first field is associated with the first field and the magnified guidance text window will be displayed in a predetermined relationship to the selected field.

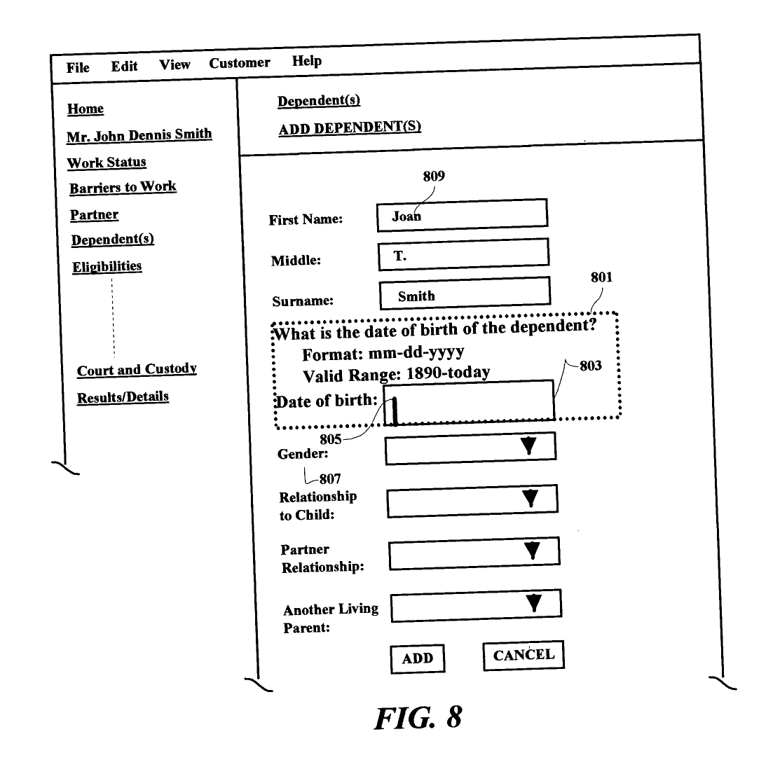

As shown in FIG. 8, when the cursor 805 is moved to the fourth field or “Date of Birth” field in the present example, the magnified guidance text window 801 is displayed above the selected field 803. In the FIG. 8 example, the guidance text is magnified for easy viewing and the guidance text provides format information for input to the selected field as well as the valid range of data for the input. When the cursor is moved to another field, the display of the “Date of Birth” field is returned to the normal display size, the information input to the “Date of Birth” field is associated with the “Date of Birth” field and the magnified guidance text window will be displayed in a predetermined relationship to the next selected field.

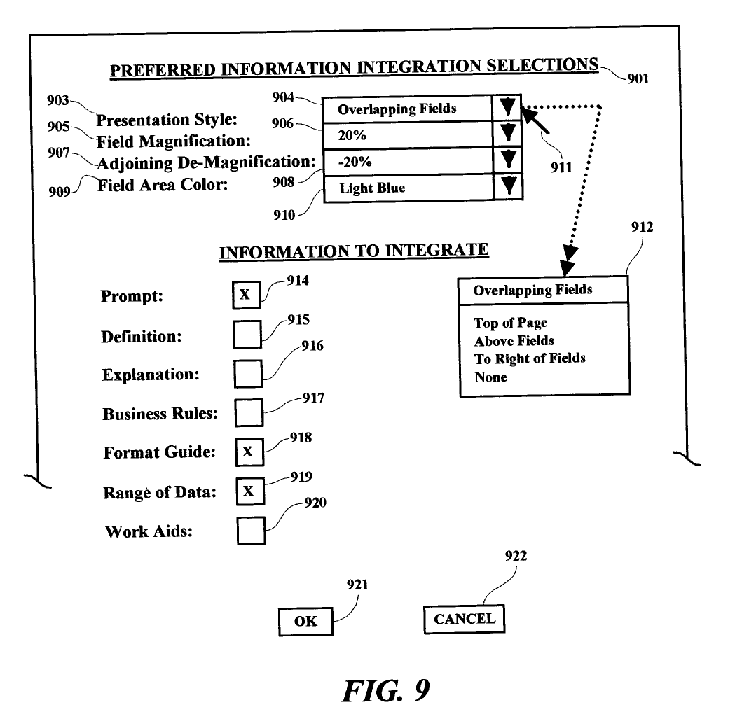

To further aid in the input of information into computer generated forms on display devices, a user preference selection mode function is provided 901 as shown in FIG. 9. In the FIG. 9 example, a user is enabled to select the presentation style 903 of the guidance text window, as well as the magnification level 905 of the guidance text window, the de-magnification 907 of the form text which adjoins the guidance text window, and other characteristics of the display including but not limited to the color of the field display area 909. As shown, the user has selected the “Overlapping Field” style 904 of guidance text window display such as illustrated in FIGS. 7 and 8. The user has also selected a “20%” magnification 906 of the guidance text window relative to the remainder of the displayed form, and a “−20%” de-magnification 908 of the text outside of the guidance window text display, and the color “Light Blue” 910 for the color of the selected field. By using the pointer 911 and clicking on the arrows to the right of the selections box, a user is enabled to select other preferences for the style, magnification and other guidance text window characteristics from pop-up windows. For example, when the pointer 911 is clicked on “Overlapping Fields”, a pop-up window enables the user to select a preferred style of presentation of the guidance text window. In addition to the “Overlapping Fields” style, the user may also have chosen a “Top of Page” style in which the guidance text window is displayed at the top of the displayed page, or “Above Fields” in which the guidance text window is displayed above the selected field as shown in FIGS. 3 and 4, or “To Right of Fields” as shown in FIGS. 5 and 6. A user may also select “None” in which case no guidance text window will be displayed. In a similar manner, a user may choose magnification and/or de-magnification levels from “10%” to “50%” or more, in any increment including but not limited to increments of “10%”, or any of a variety of colors for the selected field.

The user is also enabled to make selections to determine which extended text segments are to be displayed within the extended text or guidance text window. In the illustrated example, the user is able to select to be Prompted 914, or to have Definitions 915, Explanations 916, Business Rules 917, Format Guides 918, Range of Data 919 and/or Work Aids 920 displayed in the extended text window. An example of a work aid would be a pop-up calendar which may be used with a pointer as an aid to selecting dates to be entered into a form. After a user has input the preferred selections, the user can click on the “OK” button 921 to implement the selections in filling out displayed forms, or click on the “CANCEL” button 922 to cancel the selection operation.

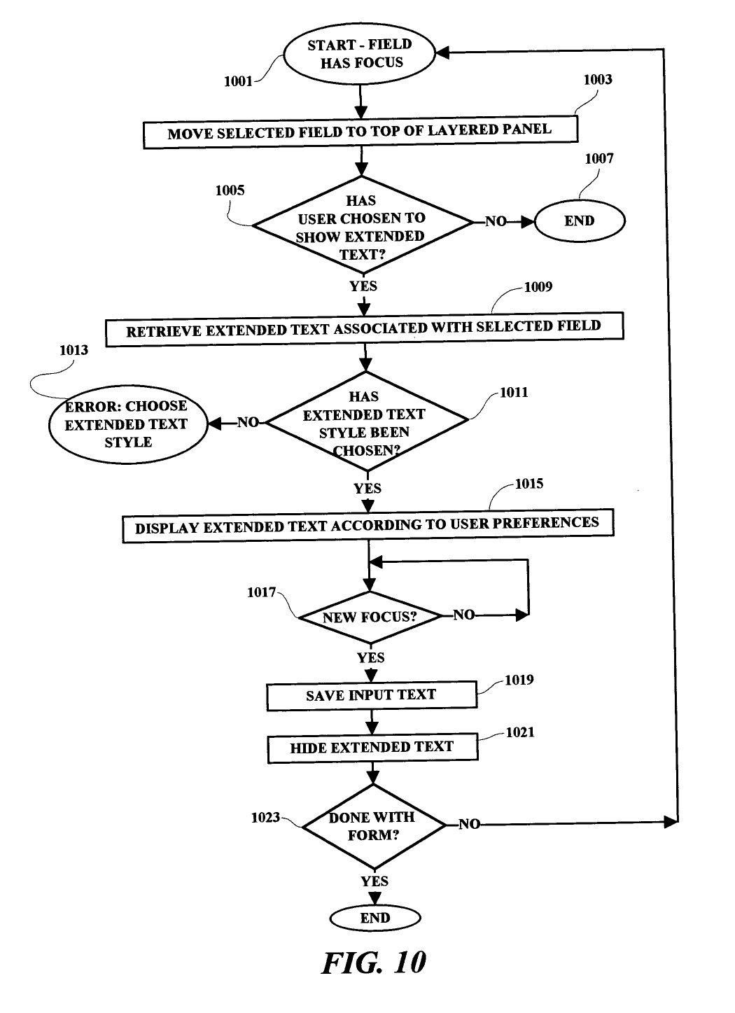

FIG. 10 illustrates a flow chart showing an operational sequence in one exemplary implementation of the present invention. As shown, the processing begins when it is detected that one of the fields or questions in the displayed form has focus 1001 such as when a user uses the pointing device and clicks with the pointer located within a selected field of a displayed form. The selected field is then moved to the top of a layered panel 1003, i.e. the selected field appears overlaid on top of the displayed form. Next, it is determined whether or not the user has chosen to show the extended text 1005, i.e. the predetermined guidance text within a guidance window. If the user has selected not to show the extended text, the process is ended 1007. If the user has selected to show the extended text 1005, then the extended text associated with the field in focus is retrieved 1009. Next, it is determined whether or not the extended text style has been chosen by the user 1011. If the user has not selected the style in which the extended text is to be displayed, an error message may be displayed to alert the user to make a display style selection to indicate where the extended text window is to be displayed relative to the field in focus. This may be accomplished by displaying the selection screen (FIG. 9) to the user when it is detected that the user has not selected the extended text presentation style. When the presentation style for the extended text has been selected 1011, the guidance window with the extended text is displayed 1015 in accordance with the user's selections (FIG. 9). When a new focus is detected 1017, i.e. when the cursor has been moved to and clicked on another field, any input text to the previous field is saved 1019 and the extended text for the previous field is hidden or removed from the display 1021. If another field has been selected for input 1023 then the processing returns to repeat the steps beginning with step 1001. Once the form has been completed and the user is done with the form 1023, then the processing is ended.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

1. A method for facilitating input of information by a user into a form displayed on a display device, said form being arranged for receiving said input into one or more input fields of said form, said method comprising:
determining when a displayed cursor is positioned within a predetermined area relative to a first input field;
accessing a data file containing a first extended information, said first extended information containing information related to said first input field;
displaying said first extended information in a first position on said display device; and
enabling said user to select a location on said display device for said first position.

2. The method as set forth in claim 1 and further including:
determining when a displayed cursor is positioned within a predetermined area relative to a second input field;
hiding said first extended information when said displayed cursor is within a predetermined area relative to said second input field;
retrieving a second extended information, said second extended information containing information related to said second input field;
displaying said second extended information in a second position on said display device; and
enabling said user to select a location on said display device for said second position.

3. The method as set forth in claim 1 and further including:
enabling said user to select a presentation style for said display of said first extended information.

4. The method as set forth in claim 3 wherein said presentation style comprises presenting said first extended information on said display device overlapping said first input field.

5. The method as set forth in claim 3 wherein said presentation style comprises presenting said first extended information on said display device above said first input field.

6. The method as set forth in claim 3 wherein said presentation style comprises presenting said first extended information on said display device to one side of said first input field.

7. The method as set forth in claim 3 and further including:
enabling said user to select a color in which said first input field is displayed on said display device.

8. The method as set forth in claim 1 and further including:
enhancing a display of said first input field relative to other text on said form when it is determined that said displayed cursor is positioned within a predetermined area relative to said first input field.

9. The method as set forth in claim 8 wherein said enhancing comprises magnifying said first input field relative to other text on said form.

10. The method as set forth in claim 9 and further including:
enabling said user to select a magnification level of said first input field relative to said form.

11. The method as set forth in claim 8 wherein said enhancing comprises maintaining relative size of said first input field while diminishing appearance of other text on said form.

12. The method as set forth in claim 1 wherein said first extended information comprises information describing a required format for input of information to said first input field.

13. The method as set forth in claim 1 wherein said first extended information comprises information describing a definition related to said first input field.

14. The method as set forth in claim 1 wherein said first extended information comprises information describing an allowable range of data related to said first input field.

15. The method as set forth in claim 1 wherein said first extended information comprises a work aid function operable to aid said user in entering information to said first input field.

16. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being selectively operable to facilitate input of information by a user into a form displayed on a display device by effecting the steps of:
determining when a displayed cursor is positioned within a predetermined area relative to a first input field;
accessing a data file containing a first extended information, said first extended information containing information related to said first input field;
displaying said first extended information in a first position on said display device; and
enabling said user to select a location on said display device for said first position.

17. A system for processing user input of information into a displayed form, said system comprising:
a system bus;
a CPU device connected to said system bus;
an input device connected to said system bus, said input device being arranged to enable user input to said system;
a display device connected to said system bus, said display device being arranged to display a form for receiving said user input into one or more input fields of said form;
means arranged for determining when a displayed cursor is positioned within a predetermined area relative to a first input field;
means for accessing a data file containing a first extended information, said first extended information containing information related to said first input field;
means for causing a display of said first extended information in a first position on said display device; and
means for enabling said user to select a location on said display device for said first position.

18. A method for facilitating input of information by a user into a form displayed on a display device, said form being arranged for receiving said input into one or more input fields of said form, said method comprising:
determining when a displayed cursor is positioned within a predetermined area relative to a first input field;
accessing a data file containing a first extended information, said first extended information containing information related to said first input field; and
displaying said first extended information in a visually enhanced state relative to other content of said form.

19. The method as set forth in claim 18 wherein said first input field and said first extended information are both presented in a magnified state within an extended information window, said first input field and said first extended information being magnified relative to other content of said form.

20. The method as set forth in claim 18 wherein user input to said first input field is displayed in said first input field of said form in said enhanced state.
